(19) United States
(12) Patent Application Publication
(10) Pub. No.: US 2009/0320649 A1
(43) Pub. Date: Dec. 31, 2009

(54) Ratchet Wrench with Three Operational Positions

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/409,576

(22) Filed: Mar. 24, 2009

(30) Foreign Application Priority Data
Jun. 27, 2008 (TW) 97124359

(51) Int. Cl. B25B 13/46

(52) U.S. Cl. 81/63.1

(57) ABSTRACT

A ratchet wrench includes a body having a closed side and a compartment receiving a drive member and two pawls. A recessed portion is formed on an outer surface of the closed side. A switch is pivotably mounted in the recessed portion between first, second, and third positions. A control member is received in the compartment and pivotable together with the switch to press against one or both of the pawls. The recessed portion includes a positioning hole receiving a pressing device. When the switch is in the first or second position, the pressing device presses against one of two lateral sides of the switch to retain the switch in place. When the switch is in the third position, the pressing device is engaged with the switch and is intermediate the lateral sides.

### BACKGROUND OF THE INVENTION

The present invention relates to a ratchet wrench and, more particularly, to a ratchet wrench with three operational positions that can be manufactured and assembled easily while allowing larger tolerances.

Reversible ratchet wrenches generally include a compartment receiving components such as a drive member, one or two pawls, and a switch device for changing the driving direction of the ratchet wrench. Two or more positioning grooves are often required for positioning the switch device. The sizes of the ratchet wrenches limit their use in confined spaces. Ratchet wrenches of a smaller size have a smaller compartment for receiving the components such that larger components cannot be used and that larger tolerances are not acceptable. Furthermore, fast assembly is not possible, for assembling of smaller components is not easy. Further, the compartment and the positioning grooves must be formed with high precision.

Taiwan Patent Publication No. 524174 discloses a reversible ratchet wrench including a head having a compartment rotatably receiving a drive member. A pawl is slideably received in a pawl groove in communication with the compartment. A control groove is formed in a side of the head and in communication with the pawl groove. The control groove includes a face having two positioning grooves facing the pawl groove. A switch is slideably received in the control groove and includes a through-hole. A pressing device is received in the through-hole of the switch and includes a ball selectively received in one of the positioning grooves and a pressing member biased by a spring to press against the pawl for engaging with the drive member. However, the distance between the positioning grooves affects sliding of the pawl, and the depth of the positioning grooves affects smooth movement of the ball between the positioning grooves. Aside from the problems including smaller tolerances of smaller components, difficult assembly, and precision formation of the compartment, the pawl groove, and the control groove, precise formation of the positioning grooves is required.

Taiwan Utility Model Publication No. M323961 discloses a reversible ratchet wrench including a head having first, second, and third compartments. A drive member is rotatably received in the first compartment. Two pawls are slideably received in the second compartment and biased away from each other by a spring to selectively engage with the drive member. A switch is pivotably received in the third compartment. Two positioning grooves are formed in a bottom wall of the third compartment. A resilient plate is fixed to a bottom of the switch and includes a protrusion engaged with one of the positioning grooves. Difficulties exist in milling the compartments and the positioning grooves in a small space in the head. Assembling and positioning the components are not easy, leading to an increase in the costs and in production time. Some of the components of the ratchet wrench are small and, thus, increase the difficulties in manufacturing and assembly.

Thus, a need exists for a ratchet wrench with three operational positions that can be manufactured and assembled easily while allowing larger tolerances.

### BRIEF SUMMARY OF THE INVENTION

The present invention solves this need and other problems in the field of easy manufacturing of ratchet wrenches by providing, in a preferred form, a ratchet wrench including a body having an open side and a closed side spaced from the open side in a thickness direction. A compartment is formed between the open side and the closed side and has a peripheral wall. The closed side of the body includes a pivot hole extending in the thickness direction and in communication with the compartment. The pivot hole defines a pivotal axis extending in the thickness direction. The closed side of the body further includes a positioning hole extending in the thickness direction and spaced from the pivot hole. A drive member is rotatably received in the compartment of the body and includes a plurality of teeth on an outer periphery thereof. First and second pawls are movably received in the compartment and releasably engaged with the teeth of the drive member. A first elastic element is mounted between the first pawl and a section of the peripheral wall of the compartment to bias the first pawl to engage with the teeth of the drive member. A second elastic element is mounted between the second pawl and another section of the peripheral wall of the compartment to bias the second pawl to engage with the teeth of the drive member. A switch is mounted outside of the compartment of the body and includes first and second ends. The second end of the switch is pivotable relative to the first end of the switch about the pivotal axis between first, second, and third positions. The switch further includes first and second lateral sides extending between the first and second ends of the switch. A pressing device is received in the positioning hole. A control member is pivotably received in the compartment and has a first end. One of the first ends of the switch and the control member extends through the pivot hole of the body and couples with the other of the first ends of the switch and the control member, such that the control member pivots about the pivotal axis when the second end of the switch pivots between the first, second, and third positions. A lid is securely received in the open side and fixed to the body to cover the compartment.

When the switch is in the first position, the control member presses against the first pawl to disengage the first pawl from the teeth of the drive member, and the second pawl is engaged with the teeth of the drive member, allowing the body and the drive member to rotate in a first direction driving a fastener in the first direction and allowing the body to rotate freely relative to the drive member in a second direction reverse to the first direction without driving the fastener. The pressing device presses against the first lateral side of the switch to retain the switch in the first position with the first lateral side of the switch intermediate the second lateral side of the switch and the pressing device.

When the switch is in the second position, the control member presses against the second pawl to disengage the second pawl from the teeth of the drive member, and the first pawl is engaged with the teeth of the drive member, allowing the body and the drive member to rotate in the second direction driving the fastener in the second direction and allowing the body to rotate freely relative to the drive member in the first direction without driving the fastener. The pressing device presses against the second lateral side of the switch to retain the switch in the second position with the second lateral side of the switch intermediate the first lateral side of the switch and the pressing device.

When the switch is in the third position, the first and second pawls are engaged with the teeth of the drive member, allowing the body and the drive member to rotate in either of the first and second directions driving the fastener and not allowing free rotation of the body relative to the drive member in either of the first and second directions without driving the fastener. The pressing device is engaged with the switch and is intermediate the first and second lateral walls of the switch to retain the switch in the third position.

In the most preferred form, the closed side of the body includes an outer surface facing away from the open side and includes an inner surface facing the open side and spaced from the outer surface in the thickness direction. The outer surface of the closed side includes a recessed portion having the pivot hole and the positioning hole. The recessed portion includes a bottom surface intermediate the open side and the closed side in the thickness direction. The recessed portion further includes first and second sidewalls extending in the thickness direction and perpendicular to the bottom surface. The first and second sidewalls are at an angle with each other. The first and second lateral walls of the switch are sandwiched between the pressing device and the first sidewall of the recessed portion when the switch is in the first position. The first and second lateral walls of the switch are sandwiched between the second sidewall of the recessed portion and the pressing device when the switch is in the second position.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a partial, perspective view of a ratchet wrench according to the preferred teachings of the present invention.

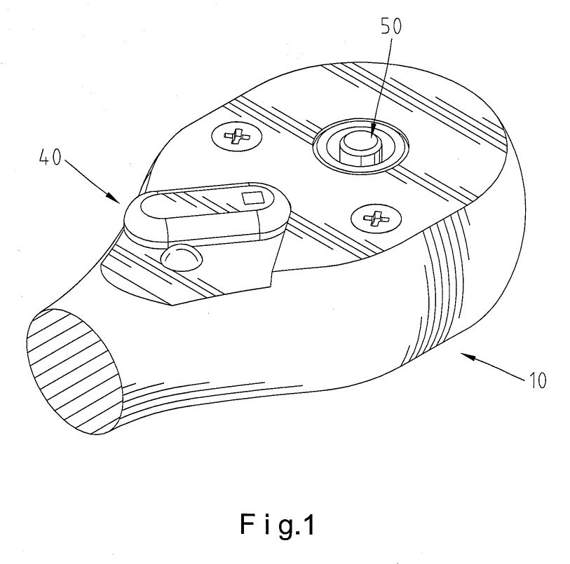

FIG. 2 shows a partial, exploded, perspective view of the ratchet wrench of FIG. 1.

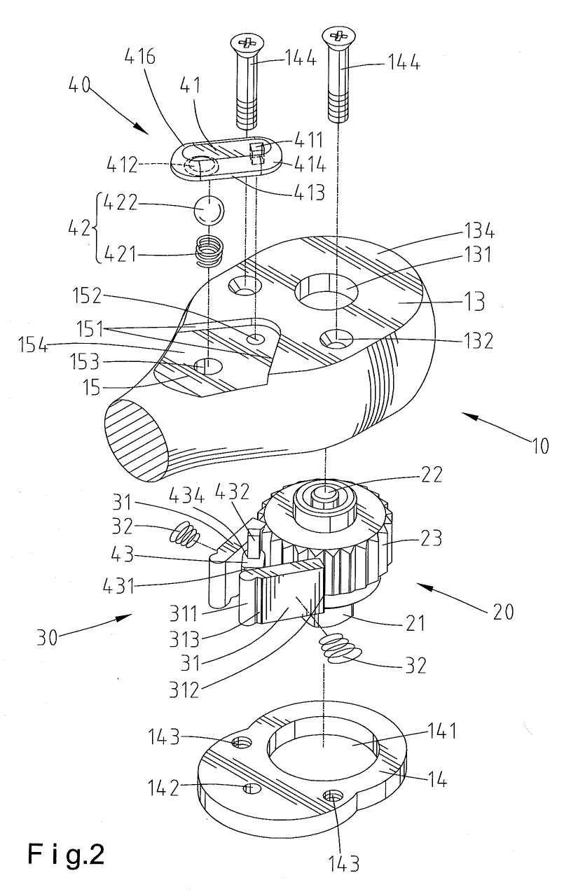

FIG. 3 shows another partial, exploded, perspective view of the ratchet wrench of FIG. 1.

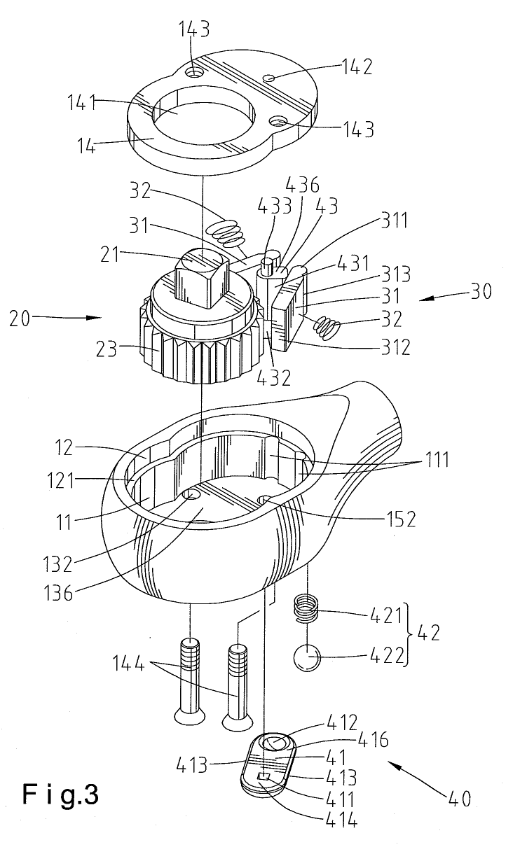

FIG. 4 shows a partial, top view of the ratchet wrench of FIG. 1 with a switch in a first position.

FIG. 5 shows a cross sectional view of the ratchet wrench of FIG. 1 with the switch in the first position.

FIG. 6 shows a partial, top view of the ratchet wrench of FIG. 1 with the switch in a transition position between the first position and a third position.

FIG. 7 shows a cross sectional view of the ratchet wrench of FIG. 1 with the switch in the transition position between the first and third positions.

FIG. 8 shows a partial, top view of the ratchet wrench of FIG. 1 with the switch in a second position.

FIG. 9 shows a cross sectional view of the ratchet wrench of FIG. 1 with the switch in the second position.

FIG. 10 shows a partial, top view of the ratchet wrench of FIG. 1 with the switch in the third position.

FIG. 11 shows a cross sectional view of the ratchet wrench of FIG. 1 with the switch in the third position.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “inner”, “outer”, “side”, “end”, “portion”, “section”, “longitudinal”, “clockwise”, “counterclockwise”, “thickness”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

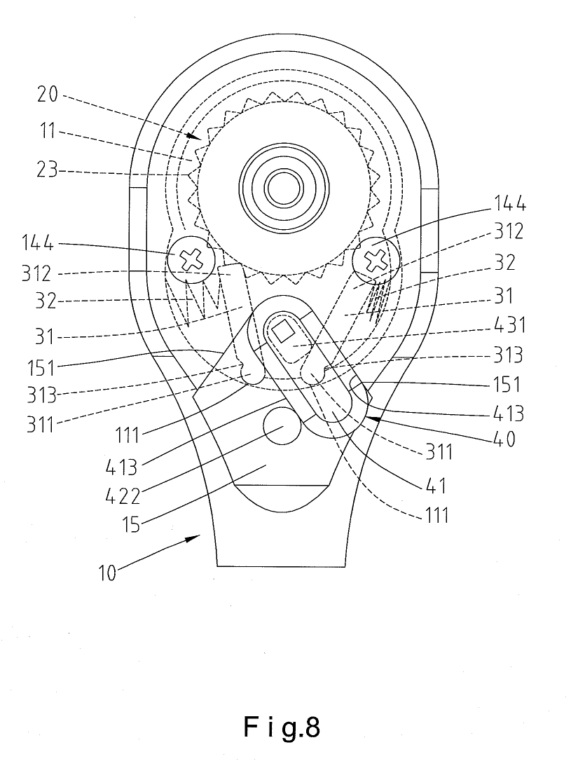

A ratchet wrench according to the preferred teachings of the present invention is shown in the drawings and generally includes a body 10 having an open side 12 and a closed side 13 spaced from inner side 12 in a thickness direction. A compartment 11 is formed between open and closed sides 12 and 13. In the most preferred form shown, compartment 11 is substantially figure 8-shaped to allow easy processing. Compartment 11 includes a peripheral wall having first and second pivotal grooves 111 adjacent a handle portion of body 10. Closed side 13 includes an outer surface 134 facing away from open side 12 and an inner surface 136 facing open side 12 and spaced from outer surface 134 in the thickness direction. An opening 131 extends from outer surface 134 through inner surface 136 of closed side 13. Also extending from outer surface 134 through inner surface 136 of closed side 13 are two fixing holes 132.

In the most preferred form shown, closed side 13 further includes a recessed portion 15 having a bottom surface 154 intermediate open side 12 and closed side 13 in the thickness direction. Recessed portion 15 further includes first and second sidewalls 151 at an acute angle with each other. First and second sidewalls 151 extend in the thickness direction and are perpendicular to bottom surface 154. A pivot hole 152 extends from bottom surface 154 through inner surface 136 of closed side 13. Pivot hole 152 defines a pivotal axis extending in the thickness direction. Further, a positioning hole 153 extends from bottom surface 154 towards but spaced from inner surface 136 of closed side 13. Body 10 includes a longitudinal axis perpendicular to the pivotal axis and the thickness direction. Positioning hole 153 has a positioning hole axis parallel to and spaced from the pivotal axis along the longitudinal axis. Furthermore, each of the positioning hole axis and the pivotal axis intersects the longitudinal axis of body 10.

In the most preferred form shown, open side 12 includes a stepped portion 121. A figure 8-shaped lid 14 is received in open side 12 and abuts stepped portion 121. Lid 14 includes a through-hole 141 coaxial with opening 131 of closed side 13. Lid 14 further includes two fixing holes 143 in the form of screw holes aligned with fixing holes 132 of closed side 13. Lid 14 further includes a pin hole 142 aligned with pivot hole 152 of recessed portion 15. Two fasteners 144 are extended through fixing holes 143 and 132 to fix lid 14 in open side 12 and, thus, cover open side 12.

According to the preferred form shown, a drive member 20 is rotatably received in compartment 13 about a rotating axis coaxial with opening 131 of closed side 13. Drive member 20 includes a plurality of teeth 23 on an outer periphery thereof. In the most preferred form shown, drive member 20 includes a first side having a coupling portion 21 in the form of a drive column extending through through-hole 141 of lid 14 for releasably coupling with a socket. Furthermore, drive member 20 includes a second side having a control portion 22 that extends through opening 131 of closed side 13 and that can be pressed to allow disengagement of the socket from coupling portion 21. Other forms of drive member 20 would be within the skill of the art.

According to the preferred form shown, a pawl device 30 including first and second pawls 31 is slideably received in compartment 11 of body 10. First pawl 31 includes a first end 311 having arcuate cross sections and pivotably received in first pivotal groove 111. Second pawl 31 includes a first end 311 having arcuate cross sections and pivotably received in second pivotal groove 111. Each of first and second pawls 31 further includes a second end 312 releasably engaged with teeth 23 of drive member 20. A first elastic element 32 in the most preferred form shown as a helical spring is mounted between a side of first pawl 31 and a section of the peripheral wall of compartment 11 to bias second end 312 of first pawl 31 to engage with teeth 23 of drive member 20. A second elastic element 32 in the most preferred form shown as a helical spring is mounted between a side of second pawl 31 and another section of the peripheral wall of compartment 11 to bias second end 312 of second pawl 31 to engage with teeth 23 of drive member 20. The sides of first and second pawls 31 face away from each other and each include a recess 313 to allow large pivotal movement of first and second pawls 31.

According to the preferred form shown, the ratchet wrench further includes a switch device 40 for changing the driving direction of the ratchet wrench. Switch device 40 includes a switch 41 pivotably received in recessed portion 15 and having first and second ends 414 and 416. Switch 41 includes an underside having a groove 412 in first end 414 and having an engaging hole 411 in second end 416. In the most preferred form shown, groove 412 is a portion of a spherical void. Switch 41 further includes parallel, spaced, first and second lateral sides 413 extending between first and second ends 414 and 416.

According to the preferred form shown, switch device 40 further includes a pressing device 42 received in positioning hole 153. In the most preferred form shown, pressing device 42 includes an elastic element 421 and a pressing member 422 in the form of a ball. Pressing member 422 is biased by elastic element 421 to partially protrude out of positioning hole 153.

According to the preferred form shown, switch device 40 further includes a control member 43 pivotably received in compartment 11 and between the other sides of first and second pawls 31. Control member 43 includes a main portion 431 having first and second ends 437 and 438 spaced in a direction perpendicular to the pivotal axis. First end 437 of control member 43 includes a first face 434 facing pivot hole 152 of recessed portion 15 and a second face 436 facing pin hole 142 of lid 14. A stub 432 extends from first face 434 along the pivotal axis and through pivot hole 152 of recessed portion 15 into engaging hole 411 of switch 41. A pin 433 extends from second face 436 along the pivotal axis and is rotatably received in pin hole 142 of lid 14. Thus, switch 41 and control member 43 can rotate jointly about the pivotal axis. Note that a center of control member 43 between first and second ends 437 and 438 is spaced from the pivotal axis in the third direction. Thus, second end 438 of control member 43 travels through a larger distance when control member 43 pivots about the pivotal axis.

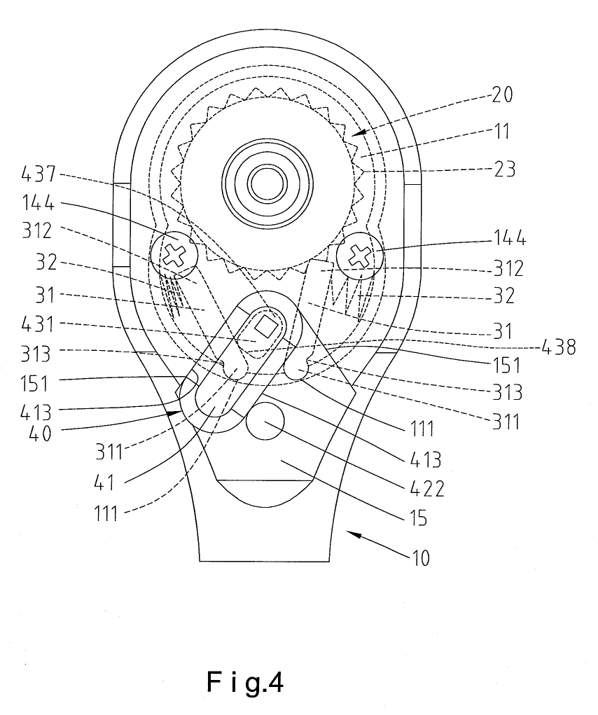

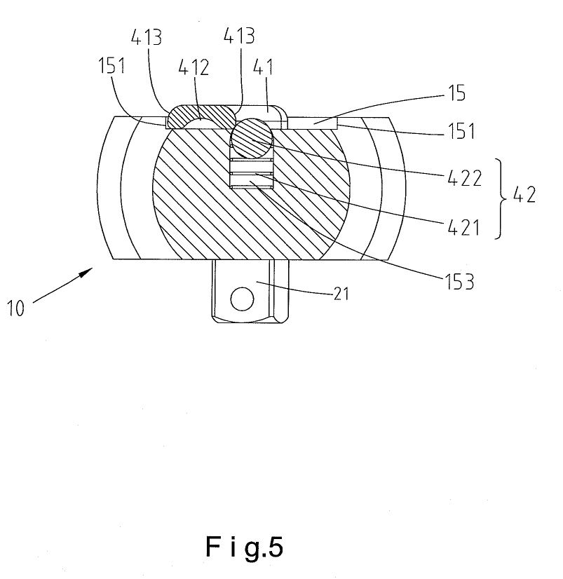

Now that the basic construction of the ratchet wrench of the preferred teachings of the present invention has been explained, the operation and some of the advantages of the ratchet wrench can be set forth and appreciated. In particular, for the sake of explanation, it will be assumed that switch 41 is in the first position (FIGS. 4 and 5). Control member 43 is in a first operative position pressing against first pawl 31 to disengage first pawl 31 from teeth 23 of drive member 20. Second end 312 of second pawl 31 is engaged with teeth 23 of drive member 20. In this state, body 10 and drive member 20 can rotate in the counterclockwise direction to drive a fastener in the counterclockwise direction. Furthermore, body 10 can rotate freely relative to drive member 20 in the clockwise direction without driving the fastener. Pressing member 422 presses against first lateral side 413 of switch 41 to retain switch 41 in the first position. Note that first lateral side 413 of switch 41 is intermediate second lateral side 413 of switch 41 and pressing member 422. Furthermore, first and second lateral walls 413 of switch 41 are sandwiched between pressing member 42 and first sidewall 151 of recessed portion 15.

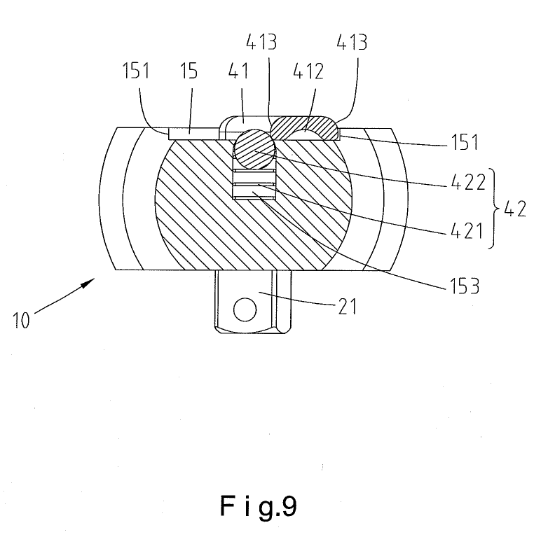

When switch 41 is in the second position (FIGS. 8 and 9), control member 43 is in a second operative position pressing against second pawl 31 to disengage second pawl 31 from teeth 23 of drive member 20. Second end 312 of first pawl 31 is engaged with teeth 23 of drive member 20. In this state, body 10 and drive member 20 can rotate in the clockwise direction to drive the fastener in the clockwise direction. Furthermore, body 10 can rotate freely relative to drive member 20 in the counterclockwise direction without driving the fastener. Pressing member 422 presses against second lateral side 413 of switch 41 to retain switch 41 in the second position. Note that second lateral side 413 of switch 41 is intermediate first lateral side 413 of switch 41 and pressing member 422. Furthermore, first and second lateral walls 413 of switch member 41 are sandwiched between second sidewall 151 of recessed portion 15 and pressing member 422.

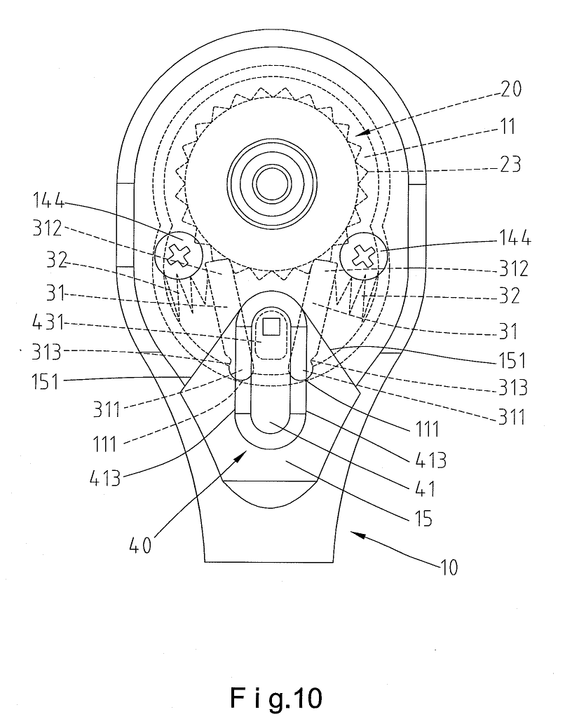

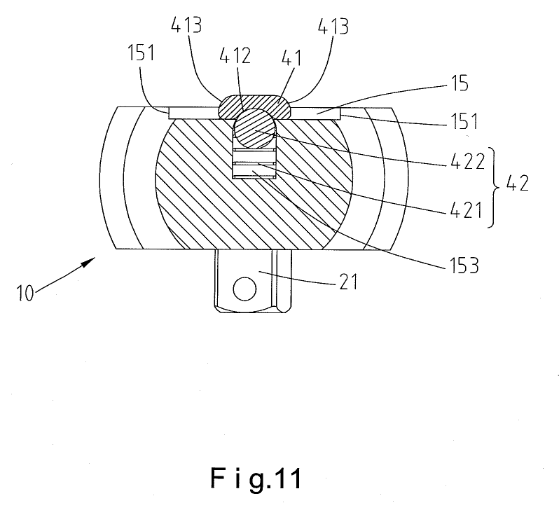

When switch 41 is in the third position (FIGS. 10 and 11), second ends 312 of first and second pawls 31 are engaged with teeth 23 of drive member 20. In this state, body 10 and drive member 20 can rotate in either clockwise or counterclockwise direction to drive the fastener in the same direction. Free rotation of body 10 relative to drive member 20 without driving the fastener is not allowed. Thus, slight tightness adjustment of the fastener is allowed when switch 41 is in the third operative position. Pressing member 422 is engaged with groove 412 of switch 41 and is intermediate first and second lateral walls 413 of switch 41 to retain switch 41 in the third position.

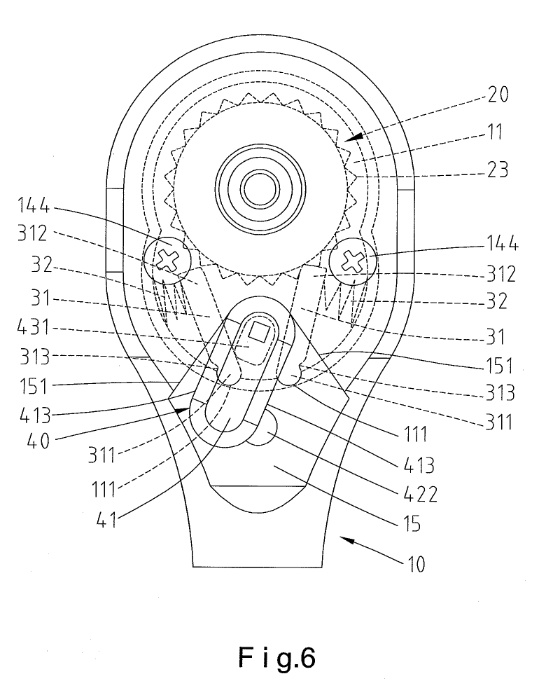

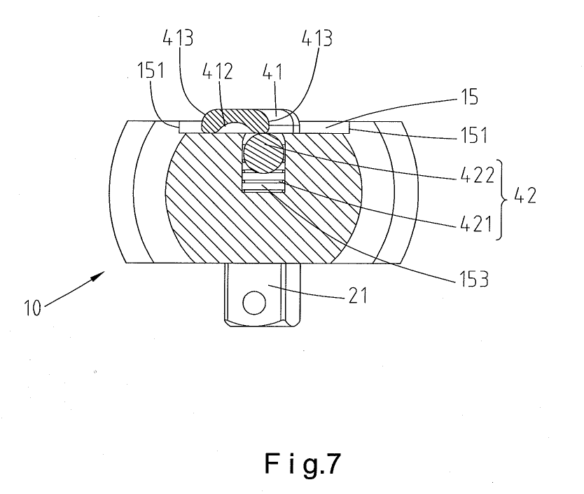

FIGS. 6 and 7 show a transition position of switch 41 between the first and third positions. Groove 412 in the form of a portion of a spherical void allows smooth movement of pressing member 422 in the form of ball into and out of groove 412. When switch 41 is pivoted between the first, second, and third positions, the underside of switch 412 can smoothly slide across pressing member 422.

Sidewalls 151 of recessed portion 15 and pressing member 422 reliably position control member 43 in first and third operative positions. Thus, formation of three positioning grooves for positioning switch 41 and control member 43 is not required. Processing can be easily accomplished with larger tolerances. The manufacturing costs can be cut while meeting the precision requirements. Furthermore, a user can easily identify the operative position of control member 43 by the position of pressing member 422 relative to switch 41.

Now that the basic teachings of the present invention have been explained, many extensions and variations will be obvious to one having ordinary skill in the art. For example, engaging hole 411 can be formed in first end 437 of control member 43 instead of first end 414 of switch 41, and stub 432 can be formed on first end 414 of switch 41 instead of first end 437 of control member 43. Likewise, pin 433 can be formed on lid 14 instead of control member 43, whereas pin hole 142 can be formed in control member 43 instead of lid 14. Furthermore, closed side 13 of body 10 does not have to include recessed portion 15 if desired. In this case, pivot hole 152 extends from outer surface 134 through inner surface 136 of closed side 13, and positioning hole 153 extends from outer surface 134 towards but spaced from inner surface 136 of closed side 13.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A ratchet wrench comprising, in combination:
a body including an open side and a closed side spaced from the open side in a thickness direction, with a compartment formed between the open side and the closed side and having a peripheral wall, with the closed side of the body including a pivot hole extending in the thickness direction and in communication with the compartment, with the pivot hole defining a pivotal axis extending in the thickness direction, with the closed side of the body further including a positioning hole extending in the thickness direction and spaced from the pivot hole;
a drive member rotatably received in the compartment of the body and including a plurality of teeth on an outer periphery thereof;
first and second pawls movably received in the compartment and releasably engaged with the plurality of teeth of the drive member;
a first elastic element mounted between the first pawl and a section of the peripheral wall of the compartment to bias the first pawl to engage with the plurality of teeth of the drive member;
a second elastic element mounted between the second pawl and another section of the peripheral wall of the compartment to bias the second pawl to engage with the plurality of teeth of the drive member;
a switch mounted outside of the compartment of the body and including first and second ends, with the second end of the switch being pivotable relative to the first end of the switch about the pivotal axis between first, second, and third positions, with the switch further including first and second lateral sides extending between the first and second ends of the switch;
a pressing device received in the positioning hole;
a control member pivotably received in the compartment and having a first end, with one of the first ends of the switch and the control member extending through the pivot hole of the body and coupled with another of the first ends of the switch and the control member, such that the control member pivots about the pivotal axis when the second end of the switch pivots between the first, second, and third positions; and
a lid securely received in the open side and fixed to the body, with the lid covering the compartment,
wherein when the switch is in the first position, the control member presses against the first pawl to disengage the first pawl from the plurality of teeth of the drive member, the second pawl is engaged with the plurality of teeth of the drive member, allowing the body and the drive member to rotate in a first direction driving a fastener in the first direction and allowing the body to rotate freely relative to the drive member in a second direction reverse to the first direction without driving the fastener, and the pressing device presses against the first lateral side of the switch to retain the switch in the first position with the first lateral side of the switch intermediate the second lateral side of the switch and the pressing device,
wherein when the switch is in the second position, the control member presses against the second pawl to disengage the second pawl from the plurality of teeth of the drive member, the first pawl is engaged with the plurality of teeth of the drive member, allowing the body and the drive member to rotate in the second direction driving the fastener in the second direction and allowing the body to rotate freely relative to the drive member in the first direction without driving the fastener, and the pressing device presses against the second lateral side of the switch to retain the switch in the second position with the second lateral side of the switch intermediate the first lateral side of the switch and the pressing device, and
wherein when the switch is in the third position, the first and second pawls are engaged with the plurality of teeth of the drive member, allowing the body and the drive member to rotate in either of the first and second directions driving the fastener and not allowing free rotation of the body relative to the drive member in either of the first and second directions without driving the fastener, and the pressing device is engaged with the switch and is intermediate the first and second lateral walls of the switch to retain the switch in the third position.

2. The ratchet wrench as claimed in claim 1, with the closed side of the body including an outer surface facing away from the open side and including an inner surface facing the open side and spaced from the outer surface in the thickness direction, with the outer surface of the closed side including a recessed portion having the pivot hole and the positioning hole, with the recessed portion including a bottom surface intermediate the open side and the closed side in the thickness direction, with the recessed portion further including first and second sidewalls extending in the thickness direction and perpendicular to the bottom surface, with the first and second sidewalls at an angle with each other, with the first and second lateral walls of the switch sandwiched between the pressing device and the first sidewall of the recessed portion when the switch is in the first position, and with the first and second lateral walls of the switch sandwiched between the second sidewall of the recessed portion and the pressing device when the switch is in the second position.

3. The ratchet wrench as claimed in claim 2, with the pressing device including a third elastic element and a pressing member biased by the third elastic element to protrude out of the positioning hole, with the switch including an underside having a groove in the second end of the switch, and with the groove receiving the pressing member when the switch is in the third position.

4. The ratchet wrench as claimed in claim 3, with the first and second sidewalls of the recessed portion defining a space, with the switch pivotably received in the space, and with the groove being a portion of a spherical void.

5. The ratchet wrench as claimed in claim 3, with the underside of the switch including an engaging hole in the first end of the switch, with the engaging hole aligned with the pivot hole of the body, with the first end of the control member including first and second faces spaced along the pivotal axis, with a stub extending from the first face of the first end of the control member along the pivotal axis, with the stub extending through the pivot hole of the body into the engaging hole of the switch, allowing joint pivotal movement of the switch and the control member about the pivotal axis.

6. The ratchet wrench as claimed in claim 5, with the control member further including a second end spaced from the first end of the control member in a third direction perpendicular to the pivotal axis, with a center of the control member between the first and second ends in the third direction being spaced from the pivotal axis in the third direction, with the second end of the control member pressing against the first pawl to disengage the first pawl from the plurality of teeth of the drive member when the switch is in the first position, and with the second end of the control member pressing against the second pawl to disengage the second pawl from the plurality of teeth of the drive member when the switch is in the second position.

7. The ratchet wrench as claimed in claim 6, with the lid including a pin hole aligned with the pivot hole, with the control member further including a pin extending from the second face of the first end of the control member along the pivotal axis, and with the pin rotatably received in the pin hole of the lid.

8. The ratchet wrench as claimed in claim 7, with the peripheral wall of the compartment of the body including first and second pivotal grooves, with the first pawl including a first end pivotably received in the first pivotal groove and a second end releasably engaged with the plurality of teeth of the drive member, and with the second pawl including a first end pivotably received in the second pivotal groove and a second end releasably engaged with the plurality of teeth of the drive member.

9. The ratchet wrench as claimed in claim 8, with the each of the first and second pawls having a side to which one of the first and second elastic elements abuts, with the sides of the first and second pawls facing away from each other, and with the side of each of the first and second pawls including a recess adjacent the first end of one of the first and second pawls.

10. The ratchet wrench as claimed in claim 3, with the body including a longitudinal axis perpendicular to the pivotal axis and perpendicular to the thickness direction, with the positioning hole having a positioning hole axis parallel to and spaced from the pivotal axis along the longitudinal axis, and with each of the positioning hole axis and the pivotal axis intersecting the longitudinal axis.

11. The ratchet wrench as claimed in claim 3, with the pivot hole extending from the bottom surface of the recessed portion through the inner surface of the closed side, and with the positioning hole extending from the bottom surface of the recessed portion towards but spaced from the inner surface of the closed side of the body.
